(19) United States
(12) Patent Application Publication
(10) Pub. No.: US 2016/0037407 A1
(43) Pub. Date: Feb. 4, 2016

(54) Radio Network Node, a Base Station and Methods Therein

(71) Applicant: TELEFONAKTIEBOLAGET L M ERICSSON (PUBL), Stockholm (SE)

(72) Inventors: Babak Alamshahi, Järfälla (SE); Peter Lundh, Skärholmen (SE); Lars O Mårtensson, Täby (SE)

(21) Appl. No.: 14/782,915

(22) PCT Filed: Apr. 8, 2013
(86) PCT No.: PCT/SE2013/050379

§ 371 Date: Oct. 7, 2015

(51) Int. Cl. H04W 36/08; H04W 36/00

(52) U.S. Cl. CPC H04W 36/08; H04W 36/0083

(57) ABSTRACT

A method in a radio network node (140) for handling hand over of a user equipment (150) to a target cell. The target cells hares a physical cell identity(PCI) with at least a second cell in a cellular communications network. When the target cells hares the PCI with the at least second cell, the radio network node (140) sends (204) a message to the respective at least two cells requesting to set up a radio link to the user equipment(150) and comprising an indication to measure a characteristic of an up link synchronization and comprising an indication to send a report comprising a result of the indicated measurement to the radio network node (140). The radio network node (140) receives from the at least two cells a respective report, which respective report comprises a result of the indicated up ink measurement. The radio network node (140) selects (209) the target cell for hand over of the user equipment (150), based on the result in the report. Publ.

### TECHNICAL FIELD

Embodiments herein relate to a radio network node, a base station and methods therein. In particular, it relates to handling handover of a user equipment to a cell sharing a locally reused physical cell identity.

### BACKGROUND

In a typical cellular communications network, also referred to as a wireless communication system, user equipments communicate via a Radio Access Network (RAN) to one or more core networks.

A user equipment is a mobile terminal by which a subscriber can access services offered by an operator's core network. The user equipments may be for example communication devices such as mobile telephones, cellular telephones, laptops or tablet computers, sometimes referred to as surf plates, with wireless capability. The user equipments may be portable, pocket-storable, hand-held, computer-comprised, or vehicle-mounted mobile devices, enabled to communicate voice and/or data, via the radio access network, with another entity, such as another mobile station or a server.

User equipments are enabled to communicate wirelessly in the cellular communications network. The communication may be performed e.g. between two user equipments, between a user equipment and a regular telephone and/or between the user equipment and a server via the radio access network and possibly one or more core networks, comprised within the cellular network.

The cellular network covers a geographical area which is divided into cell areas. Each cell area is served by a base station.

A cell is the geographical area where radio coverage is provided by the base station at a base station site. One base station, situated on the base station site, may serve one or several cells. Further, each base station may support one or several communication technologies. The base stations communicate over the air interface operating on radio frequencies with the user equipments within range of the base stations.

In some radio access networks, several base stations may be connected, e.g. by landlines or microwave, to a controlling radio network node, e.g. a Radio Network Controller (RNC) in Universal Mobile Telecommunications System (UMTS), and/or to each other.

In 3rd Generation Partnership Project (3GPP) Long Term Evolution (LTE), base stations, which may be referred to as eNodeBs or eNBs, may be directly connected to one or more core networks.

UMTS is a third generation, 3G, mobile communication system, which evolved from the second generation, 2G, mobile communication system Global System for Mobile communications (GSM), and is intended to provide improved mobile communication services based on Wideband Code Division Multiple Access (WCDMA) access technology. UMTS Terrestrial Radio Access Network (UTRAN) is essentially a radio access network using wideband code division multiple access for user equipments. The 3GPP has undertaken to evolve further the UTRAN and GSM based radio access network technologies.

Cellular networks evolve towards higher data rates, together with improved capacity and coverage. In 3GPP, standardization body technologies like GSM, High Speed Packet Access (HSPA) and LTE have been and are currently developed.

In the context of this disclosure the expression DownLink (DL) will be used for the transmission path from the base station to the user equipment. The expression UpLink (UL) will be used for the transmission path in the opposite direction i.e. from the user equipment to the base station.

To support mobility of user equipments between cells in a cellular network, so called handovers are performed. A handover may be a change of serving cell, so that a user equipment being served by one cell becomes served by another, so-called target cell, instead. A handover may also mean addition of a radio link to a target cell without removing established radio links to other cells; or replacement of one of the existing radio links by a radio link to a target cell. Communication that involves a multitude of cells may be referred to as macro diversity, soft handover or softer handover. Handover may also involve changing radio access technology, so called inter radio access technology handover. For example, a user equipment configured to operate in for example LTE or GSM wants to do handover to a system using WCDMA radio access technology. Another example of handover is inter-frequency handover, in which a user equipment configured to operate with a specific frequency wants to do handover to another frequency. The set of cells with which the user equipment have radio links is referred to as the active set. Hence, a handover includes the setup of a radio link connection between the user equipment and the target cell, so that the target cell may become the serving cell for the user equipment.

Some cellular networks feature soft handover where a user equipment may be allocated a multitude of radio links. These radio links may be with the same base station or different base stations. Furthermore, the base stations may be controlled by different nodes, such as for example different RNCs.

Neighbor cell relations may be used to facilitate handover of the user equipment between base stations. In UTRAN, the user equipment is provided with a so called neighbor cell list comprising cell identifiers, or indexes associated with cell identifiers, of plausible target cells to search for and perform measurements on. The user equipment is provided with the neighbor cell list by its so called serving RNC, which is also the RNC to which it reports when a target cell is detected.

A set of cells with radio links to the user equipment are referred to as the active set of cells, while additional cells listed in the neighbor cell list constitute a monitored set of cells, which are searched for and reported upon detection. Moreover, the user equipment may also consider, detect and report cells not listed in the neighbor cell list. These cells may be referred as a detected set of cells. One issue with the detected set of cells may be significantly looser reporting requirements, such as longer report times, compared to the reporting requirements for cells in the neighbor cell list.

Each cell in the cellular network broadcasts a defined signature sequence, a so-called Physical Cell Identity (PCI). In UTRAN, this sequence is in the form of a primary Scrambling Code (pSC). The PCIs are reused in the cellular communications network, and are therefore not globally unique. They may however be perceived as locally unique by careful selection, and thereby they may be used by the serving RNC to unambiguously identify target cells for handover when the user equipment reports them. The user equipment regularly performs measurements to detect PCIs which are broadcast in its vicinity.

Because of PCIs being reused they may however in some situations not be even locally unique, due to for example a large amount of cells being present in an area. Locally non-unique PCIs may be a problem for the cellular communications network when it is necessary to establish a unique identity of a cell. Confusion of cell identities may degrade the performance of the cellular communications network.

### SUMMARY

An object of embodiments herein is to provide a way of improving the performance of a cellular communications network.

According to a first aspect of embodiments herein, the object is achieved by a method in a radio network node for handling handover of a user equipment to a target cell. The target cell shares a Physical Cell Identity, PCI, with at least a second cell in a cellular communications network. The cellular communications network comprises the radio network node, the user equipment and the at least two cells sharing the PCI. When the target cell is one of the at least two cells sharing the physical cell identity, the radio network node sends a message to the respective at least two cells. Each message requests to set up a Radio Link, RL, to the user equipment. The message comprises an indication to measure a characteristic of an UpLink, UL, synchronization of the respective at least two cells with the user equipment. Further, the message comprises an indication to send a report comprising a result of the indicated measurement to the radio network node.

The radio network node receives from at least one of the at least two cells a respective report. The respective report comprises a result of the indicated UL measurement.

The radio network node selects the target cell for handover of the user equipment, based on the result in the report.

According to a second aspect of embodiments herein, the object is achieved by a radio network node for handling handover of a user equipment to a target cell. The target cell shares a Physical Cell Identity, PCI, with at least a second cell in a cellular communications network. The cellular communications network comprises the radio network node, the user equipment and the at least two cells sharing the PCI.

The radio network node comprises a sending circuit configured to send a message to the respective at least two cells, when the target cell is one of the at least two cells sharing the PCI. Each message requests to set up a Radio Link, RL, to the user equipment. The message comprises an indication to measure a characteristic of an UpLink, UL, synchronization of the at least two cells with the user equipment. Further, the message comprises an indication to send a report comprising a result of the indicated measurement to the radio network node.

Further the radio network node comprises a receiving circuit configured to receive from at least one of the at least two cells a respective report. The respective report comprises a result of the indicated UL measurement.

Further the radio network node comprises a selecting circuit configured to select the target cell for handover of the user equipment, based on the result in the report.

According to a third aspect of embodiments herein, the object is achieved by a method in a base station for handling handover of a user equipment to a target cell. The target cell shares a physical cell identity, PCI, with at least a second cell in a cellular communications network. The cellular communications network comprises a radio network node, the user equipment, the at least two cells sharing the PCI and the base station. The base station serves the target cell. The base station interprets a received message from the radio network node, which message requests to set up a Radio Link, RL, to the user equipment. The message is interpreted as an indication to measure a characteristic of an UpLink, UL, synchronization of the at least two cells with the user equipment. Further the base station interprets the message as an indication to send a report to the radio network node in response to the message from the radio network node. The report comprises a result of the indicated UL synchronization measurement. The result will be used by the radio network node for selecting the target cell for handover of the user equipment.

According to a fourth aspect of embodiments herein, the object is achieved by a base station for handling handover of a user equipment to a target cell. The target cell shares a physical cell identity, PCI, with at least a second cell in a cellular communications network. The cellular communications network comprises a radio network node, the user equipment, the at least two cells sharing the PCI and the base station. The base station serves the target cell. The base station comprises an interpreting circuit configured to interpret a received message from the radio network node, which message requests to set up a Radio Link, RL, to the user equipment. The message is interpreted as an indication to measure a characteristic of an UpLink, UL, synchronization of the respective at least two cells with the user equipment. Further the interpreting circuit is configured to interpret the message as an indication to send a report to the radio network node in response to the message from the radio network node, the report comprising a result of the indicated UL synchronization measurement. The result will be used by the radio network node for selecting the target cell for handover of the user equipment.

Since the radio network node receives from at least one of the at least two cells a respective report, which respective report comprises a result of the indicated UL measurement, the radio network node is able to select the target cell for handover of the user equipment based on an unambiguous cell identification. This provides an improved way of handling a reuse of a PCI in the cellular communications network. In this way the performance of the cellular communications network is improved.

### BRIEF DESCRIPTION OF THE DRAWINGS

Examples of embodiments herein are described in more detail with reference to attached drawings in which:

FIG. 1 is a schematic block diagram illustrating some embodiments of a cellular communications network.

FIG. 2 is a schematic combined flowchart and signaling scheme of embodiments of a cellular communications network.

FIG. 3 is a flowchart depicting embodiments of a method in a radio network node.

FIG. 4 is a schematic block diagram illustrating embodiments of a radio network node.

FIG. 5 is a flowchart depicting embodiments of a method in a base station.

FIG. 6 is a schematic block diagram illustrating embodiments of a base station.

### DETAILED DESCRIPTION

As part of developing embodiments herein, a problem will first be identified and discussed below.

As mentioned above each cell in the cellular network broadcasts a defined signature sequence, a so-called Physical Cell Identity (PCI). In UTRAN, this sequence is in the form of a primary Scrambling Code (pSC). The PCIs are reused in the cellular communications network, and are therefore not globally unique. They may however be perceived as locally unique by careful selection, and thereby they may be used by the serving RNC to unambiguously identify target cells for handover when the user equipment reports them. The user equipment regularly performs measurements to detect PCIs which are broadcast in its vicinity.

Because of PCIs being reused they may however in some situations not be even locally unique, due to for example a large amount of cells being present in an area. For example, there is only 512 pSCs in UTRAN. On the other hand the number of cells in a radio network which a certain operator has deployed, or will deploy, may be in the order of 10 000 to 50 000 cells or more. Thus, the available number of available pSCs in UTRAN is limited, much fewer than the number of real cells.

When a user equipment wants to perform a handover to another cell it sends a measurement report with an event via the radio resource control protocol up to the serving radio network controller with the type of handover it wants to do, for example adding a cell to its active set. The target cell information in such an event is only the PCI, which may be a problem. Why this may be a problem will be explained below.

In addition to the reused PCIs, the base stations broadcast globally unique cell identifiers, so called Cell Global Identifiers (CGIs). However, in order to keep the target cell measurement procedures simple, these may not be decoded and reported to the serving RNC for target cell discovery purposes. The normal case is that the user equipments do not use the CGI for handover since it takes too long time and is cumbersome to read the CGIs.

In an example scenario the PCIs are reused in a cellular communications network. Therefore they are not globally unique.

Ideally, these non-unique PCIs should at least be locally unique in the cellular network. However, with many small cells such as for example Pico cells, and possibly also a reserved range of PCIs for small cells, this may not be the case. Problems start to occur with colliding PCIs when the cellular communications network becomes more dense, i.e. introduction of more small cells, or when the cellular communications network comprises cells with big cell size differences, or when the cellular communications network becomes more three dimensional, e.g. indoor or at tall buildings, or when cell planning is not optimal when the network grows, or when antenna types are not changed when extending a site from 3 to 6 sectors, or when antenna directions are not maintained optimally when the network grows, or when the PCIs are not used evenly in the network.

Hence, it may be the case that two or more cells, such as for example two Pico cells, within the coverage of the same macro cell are assigned the same physical cell identity. For example, a target cell and another cell share a locally reused physical cell identity, for example in the form of a pSC.

This means that when a user equipment sends a measurement report comprising a pSC to the controlling radio network node, such as for example the serving radio network controller, the controlling radio network node cannot, based on the measurement report, uniquely identify which cell the reported pSC originated from. This prevents unique identification of the target cell for a handover and is sometimes referred to as scrambling code confusion. Not being able to uniquely identify the target cell for handover is a problem from a radio performance point of view. The user equipments may do handover to the wrong cells, with radio performance degradation as a result.

Also, a limited neighbor cell list length, which may be limited to 31 different pSC indexes, and the loose reporting requirements for the detected set may render handover to a target cell difficult. When the cellular communications network already has problems with colliding PCIs, such as for example colliding pSCs, and when the operator wants to add small cells here and there in the network to cope with coverage holes and capacity gains in crowdie areas, then the problem with colliding PCIs increase. So, there is a need to be able to re-use PCIs in a more dense way.

Embodiments herein addresses the problem of selecting a target cell for handover of a user equipment, when the target cell shares the physical cell identity, such as a primary scrambling code, with at least another cell in a cellular communications network. According to embodiments herein the object is achieved by selecting a target cell for handover of the user equipment based on measurements of the UL synchronization of the respective cells with the user equipment. Such measurements result in unambiguous cell identification, since the target cell can be selected even if several cells detect UL synchronization, i.e. can communicate with the user equipment. If several cells detect UL synchronization the cell with the best or most suitable measurement result is selected. It is also a fundamental benefit that the embodiments herein do not need to send specific messages or perform specific measurements compared to those needed to perform a normal handover.

A further advantage of embodiments herein is that the selection of the target cell necessary for handover of a user equipment may be provided for without the user equipment having to decode and/or report for example a globally unique cell identity of a target cell.

Embodiments herein are defined as a radio network node, a base station and methods therein which may be put into practice in the embodiments described below. Further, embodiments herein are described with some reference to 3GPP UMTS but it should be noted that the embodiments may be applied also in other cellular communications networks such as, e.g. 3GPP LTE.

To improve the possibility to do handover to a cell, such as for example a Pico cell, which uses the same PCI as other cells in the neighborhood, such as for example other Pico cells, embodiments herein provides a method to select a target cell for handover of a user equipment based on the performance of measurements of the radio channel between a user equipment and a cell.

The method doesn't limit the usage to the typical case where Pico cells are deployed within a Macro cell. Further, the method is not limited to cells using the same radio access technology and same frequency. The method may for example also involve inter radio access technology handover or inter frequency handover.

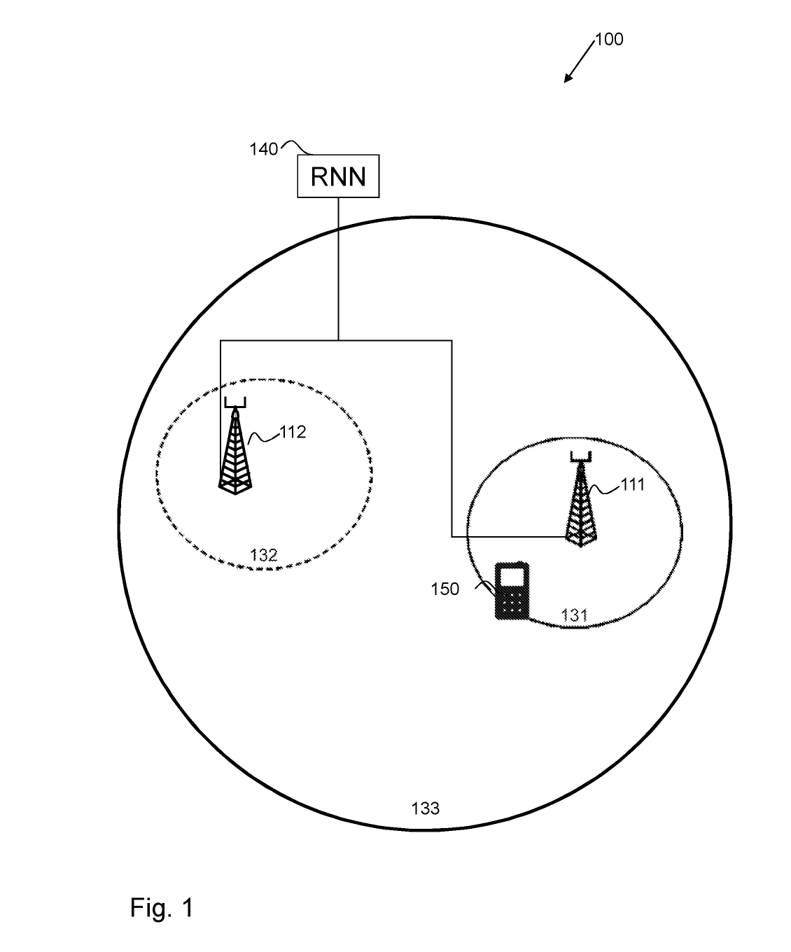

FIG. 1 depicts a cellular communications network 100 in which embodiments herein may be implemented. The cellular communications network 100 may be for example an UMTS, LTE or any other 3GPP cellular network.

The cellular communications network 100 comprises a first base station, also referred to as the base station 111, and in some embodiments a second base station 112. The base station 111 serves a first cell, also referred to as a target cell 131 in FIG. 1. The base station 111 may in some embodiments serve a second cell 132, and in some other embodiments the second base station 112 serves the second cell 132. The cellular communications network 100 further comprises a third cell 133, which third cell 133 is served by a base station not shown in FIG. 1.

The base station 111 and the second base station 112 may each be e.g. Radio Base Stations (RBS), which sometimes may be referred to as e.g. “nodeB”, “B node”, or Base Transceiver Station (BTS), depending on the technology and terminology used. The base stations may be of different classes such as e.g. macro NodeBs, home NodeBs or Pico base stations, based on transmission power and thereby also on cell size. In this example, the base stations are Pico base stations.

The cellular communications network 100 further comprises a radio network node 140, which is referred to as the RNN 140 in FIG. 1. The radio network node 140 may for example be an RNC in an UMTS system or an eNodeB in an LTE system. The radio network node 140 may supervise and coordinate various activities of base stations connected thereto, such as the base station 111 and the second base station 112.

By “controlling a base station” is understood that the radio network node 140 controls the radio resources and radio connectivity within a set of cells that is served by the base station.

As is illustrated in FIG. 1, the base station 111 and the second base station 112 and the radio network node 140 controlling the base station 111 and second base station 112 are connected to each other. By way of example, in FIG. 1, the connection between a base station and its controlling radio network node is referred to as an lub interface. In some embodiments, the connections may be other interfaces. The connections may be provided via land lines, radio link or a combination thereof. Naturally, there may be more than two cells and base station in the cellular communications network 100.

A user equipment 150 is located in the third cell 133, which is its serving cell. The user equipment is moving towards the target cell 131. To provide mobility to user equipments such as the user equipment 150 in the cellular network 100, it is possible to provide handovers in the cellular network 100. The handover may be a change of serving cell, so that the user equipment 150 being served by the third cell 133 becomes served by another cell, here the target cell 131, instead. The handover of the user equipment 150 to the target cell 131 includes the setup of a radio link connection between the user equipment 150 and the target cell 131, so that the target cell 131 may become the serving cell for the user equipment 150.

A defined signature sequence, such as a primary scrambling code, is broadcast in each cell in the cellular communications network 100. The primary scrambling codes are enumerated and associated with a cell identity.

Handover from one cell to another is performed based on so called measurement reports from the user equipment 150, in which the user equipment 150 reports which pSC it has detected. A measurement report is sent to the serving radio network controller, i.e. to the radio network node 140 in this example, and the serving radio network controller may, based on the report, identify the target cell 131 for handover of the user equipment 150.

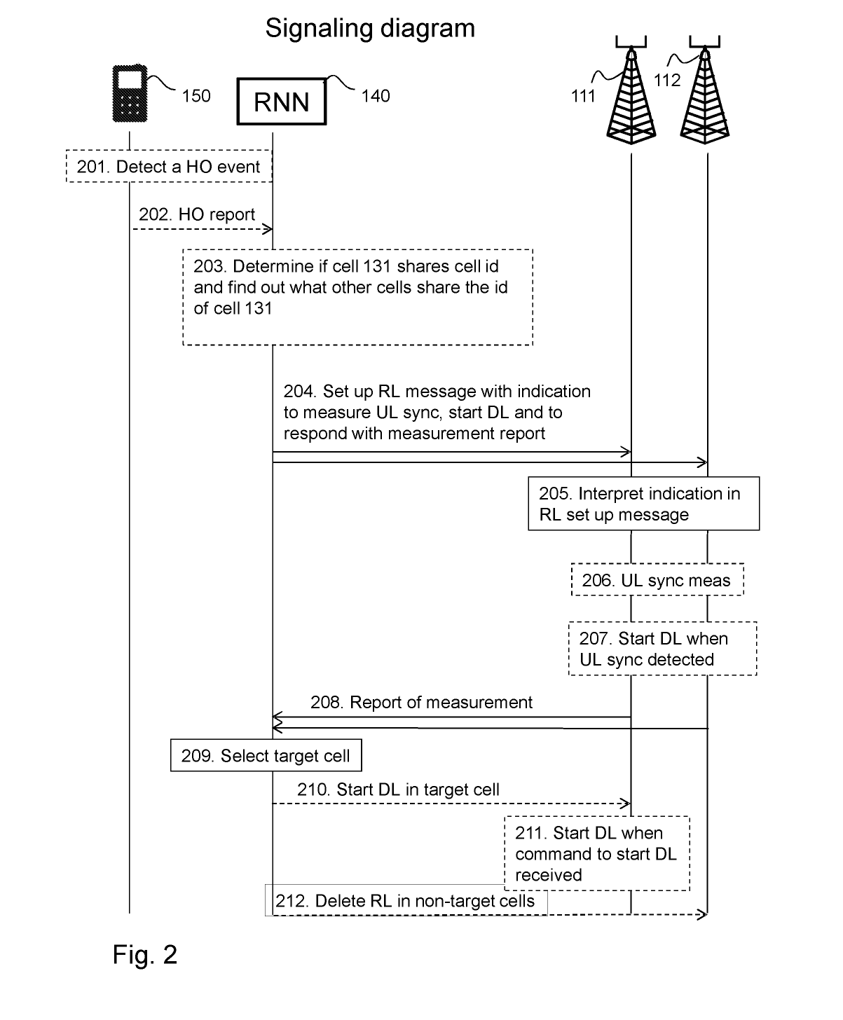

FIG. 2 is a schematic combined flowchart and signaling scheme illustrating a method for handling handover of the user equipment 150 to the target cell 131. In this example the target cell 131 shares a locally reused PCI, such as for example a pSC, with the second cell 132 in the cellular communications network 100.

As mentioned above the target cell 131 is served by the base station 111, while the second cell 132 may be served by the second base station 112. The base station 111 and the second base station 112 are controlled by the radio network node 140. The radio network node 140, the user equipment 150, the target cell 131, the second cell 132, the base station 111 and the second base station 112 are comprised in the cellular communications network 100.

Actions for handling handover of the user equipment 150 to the target cell 131 will now be described with reference to FIG. 2. The actions do not have to be performed in the order stated below, but may be taken in any suitable order. Further, actions may be combined.

Action 201

In order to facilitate handover the radio network node 140 has configured the user equipment 150 to measure on neighbor cells both via the cell broadcast info and via dedicated measurements for this very user equipment 150 via Measurement Control. In some embodiments the user equipment 150 detects a handover event indicating a handover to the target cell 131 from these measurements.

Action 202

Since the radio network node 140 determines whether to perform handovers or not, the radio network node 140 should be informed about any request for a handover. Therefore the user equipment 150 may send a measurement report with an event for a wanted handover to the target cell 131 to the radio network node 140. For example with a so-called event 1a, which means adding a cell to the active set. The event in the measurement report comprises the PCI, such as for example the pSC, of the target cell 131 as the only reference to the target cell 131.

Action 203

One way for the radio network node 140 of doing handover to a cell is by comparing the PCI reported by the user equipment in action 202 with the PCIs stored in the neighbor set, i.e. all unique neighbor cells to the active set cells. However, since the PCI of the target cell 131 does not identify the target cell 131 unambiguously the radio network node 140 need to determine whether or not the target cell 131 shares the PCI with other cells, such as the second cell 132. If the target cell shares the PCI with other cells, then handover might be done to the wrong cell if the handover is based only on comparing the PCI in the measurement report from the UE 150, with the PCIs stored in the neighbor set. Therefore in some embodiments the radio network node 140 determines whether the target cell 131 is one of the at least two cells 131, 132 sharing the PCI or not when the radio network node 140 has received a handover event to the target cell 131 from the user equipment 150.

The radio network node 140 may use different methods to determine if the target cell 131 shares the PCI with the second cell 132 or not.

This action may be performed by comparing the PCI of the target cell 131 to one or more ranges of PCIs dedicated to cells sharing PCI. In this way the radio network node 140 knows directly if the pSC received in the report for handover is locally reused or not.

In some alternative embodiments this action may be performed by reading information about whether the PCI is locally reused or not stored in the neighbor set.

When the radio network node 140 has determined that the target cell 131 is one of the at least two cells 131, 132 sharing the PCI, the radio network node 140 may determine which other cells that share the PCI.

Action 204

The radio network node 140 now knows that the target cell 131 shares the PCI with at least the second cell 132. If the radio network node 140 would send a message to the user equipment 150 to perform handover to the cell with the PCI of the target cell, this would be an ambiguous message, which may result in a handover to the wrong cell. Therefore the radio network node 140 cannot select the target cell 131 based on only the PCI. Some additional information is required in order to make an unambiguous selection. Such information may for example be a result of a measurement made on the radio connection between the first cell 131 and the user equipment 150 and between the second cell 132 and the user equipment 150.

In order to get hold of such additional information for the unambiguous selection of the target cell 131 the radio network node 140 sends a message to the respective at least two cells 131, 132 when the target cell 131 is one of the at least two cells 131, 132 sharing the PCI. Each message requests to set up a RL to the user equipment 150 and comprises an indication to measure a characteristic of an UL synchronization of the respective at least two cells 131, 132 with the user equipment 150. The message further comprises an indication to send a report comprising a result of the indicated measurement to the radio network node 140.

When received, the radio network node 140 may compare the result of the indicated UL measurement of the radio link between the user equipment 150 and the target cell 131 with the result of the indicated UL measurement of the radio link between the user equipment 150 and the second cell 132. Based on this comparison the radio network node 140 will be able to select the target cell 131 unambiguously.

Instead of sending several specific messages to the respective cells 131, 132 for setting up the RL, commanding to perform a measurement of a characteristic of an UL synchronization and sending the measurement to the radio network node 140 only one message is sent. The one message comprises the indication, i.e. an implicit instruction to perform a measurement and to send the measurement to the radio network node 140. Since only one message is used to indicate several tasks, the cellular communications network 100 will save communication resources, which communication resources then are available for other communication purposes.

The indication may indicate to start a DL radio connection in the respective at least two cells 131, 132 when the UL synchronization has been detected. Starting the DL radio connection directly after UL synchronization reduces the number of signaling steps compared to sending an explicit signal to start the DL radio connection when the target cell 131 has been selected and thus may improve the performance of the network.

In some other alternative embodiments the indication indicates to start a DL radio connection in the respective at least two cells 131, 132 when a command to start the DL radio connection to the user equipment 150 has been received. Starting the DL radio connection from only the target cell 131 may save radio resources.

In some embodiments the sent message to the respective at least two cells 131, 132 is a Radio Link (RL) Setup Request message.

The indication comprised in the RL Setup Request message may be an Information Element (IE) “Delayed Activation” set to be active.

Action 205

When the base station 111 serving the target cell 131 and the second base station 112 serving the second cell 132 have received the message requesting to set up the RL connection to the user equipment 150, sent by the radio network node 140 in action 204, the base station 111 and the second base station 112 each interprets the received message as the indication to measure the characteristic of the UL synchronization of the at least two cells 131, 132 with the user equipment 150. The message is further interpreted as the indication to send the report to the radio network node 140 in response to the message from the radio network node 140. The report comprises the result of the indicated UL synchronization measurement. The result will be used by the radio network node 140 for selecting the target cell 131 for handover of the user equipment 150.

Since only one received message is interpreted as an indication to perform several tasks, the cellular communications network 100 will save communication resources, which communication resources then are available for other communication purposes.

The received message may be an RL Setup Request message comprising an Information Element, IE, “Delayed Activation”, which is set to be active, and which IE “Delayed Activation” set to be active is interpreted as the indication to measure the characteristic of the UL synchronization.

In some embodiments the received message is further interpreted as to start the DL radio connection between the user equipment 150 and the base station 111 when the UL synchronization has been detected.

In some alternative embodiments the received message may be interpreted as an indication to start a DL radio connection in the respective at least two cells 131, 132 when a command to start the DL radio connection to the user equipment 150 has been received, i.e. not directly after UL synchronization but after the target cell 131 has been selected. The command may be a “Radio link activation command”.

Action 206

The base station 111 and the second base station 112 may each measure a characteristic of the UL synchronization according to the interpreted indication in the received message from the radio network node 140.

In some embodiments this action is performed by measuring a signal strength of the UL synchronization. The signal strength measured by the target cell 131 will in most cases be higher than the signal strength measured by the second cell 132. Thus selection of the target cell 131 based on the result of the measurement of the signal strength of the UL synchronization will be unambiguous.

This action may also be performed by measuring a detection time of the UL synchronization. The measured detection time is a good estimate of the distance between the user equipment 150 and the base station 111, and of the distance between the user equipment 150 and the second base station 112. The shorter the distance is the shorter will the detection time be. The detection time measured by the target cell 131 will in most cases be shorter than the detection time measured by the second cell 132. Thus selection of the target cell 131 based on the result of the measurement of detection time of the UL synchronization will be unambiguous.

Action 207

In some embodiments the sent message to the respective at least two cells 131, 132 comprises the indication to start a DL radio connection in the respective at least two cells 131, 132 when the UL synchronization has been detected. If this is the case the base station 111 and the second base station 112 may each start the DL radio connection to the UE 150 in the respective at least two cells 131, 132, when the UL synchronization has been detected without the need for further commands from the radio network node 140.

Action 208

When the base station 111 and the second base station 112 have measured the characteristic of the UL synchronization of the respective at least two cells 131, 132 with the user equipment 150 the base station 111 and the second base station 112 may each send the report to the radio network node 140 in response to the received message in action 205. The report may comprise a result of the indicated UL measurements and the result will be used by the radio network node 140 for selecting the target cell 131 for handover of the user equipment 150.

The respective report may comprise a result of a measurement of the signal strength of the UL synchronization.

In some alternative embodiments the report comprises a result of a measurement of the detection time of the UL synchronization.

The report may be comprised in a “RL Restore Indication” message, which message is used to send reports to radio network nodes when a base station detects UL synchronization.

Action 209

When the radio network node 140 has received reports for a certain configurable period of time, e.g. for a couple of seconds, the radio network node 140 judges which one of the cells to proceed with for the handover. If several cells answer, for example with the “RL Restore Indication” message, the radio network node 140 may select the cell with the highest UL measurement performance. If no cell answers within a certain time the target cell 131 cannot be identified and selected for handover.

In this example the radio network node 140 selects the target cell 131 for handover of the user equipment 150 based on the result in the respective report sent from the base station 111 and the second base station 112, since the target cell 131 has the best result, i.e. the highest UL measurement performance.

As mentioned above the respective report that may be sent in action 208 above may comprise a result of a measurement of a signal strength of the UL synchronization.

In some embodiments the received respective report comprises a result of a measurement of a detection time of the UL synchronization.

Action 210

When the target cell 131 has been selected for handover, the radio network node 140 may send a command to the target cell 131 commanding to start the DL radio connection to the user equipment 150. The command to start the DL radio connection may be a “Radio link activation command”. This step may be performed if the base station 111 has interpreted the message requesting to set up the RL to the user equipment 150 as an indication to start the DL radio connection between the user equipment 150 and the base station 111 when the command to start the radio connection to the user equipment 150 has been received.

Action 211

In some embodiments when the base station 111 has received the command to start the DL radio connection to the user equipment 150 in action 210 the base station 111 starts the DL radio connection to the user equipment 150.

Action 212

In order to not use more communication resources than necessary the radio network node 140 may delete the RL connection between the user equipment 150 and the at least two cells 131, 132 for any non-selected cell out of the at least two cells 131, 132 sharing the PCI. In this example the RL connection between the user equipment 150 and the second cell 132 is deleted. The deleting of the RL connection may be performed explicitly, with for example a deletion message, while in some embodiments the deleting of the RL connection is performed by time-out. Time-out means that the RL is deleted because no report was sent to the radio network node 140 within a certain time. For example, the report was not sent because the second cell 132 could not detect UL synchronization within a certain time. The time for the time-out may be set shorter when several cells share the same PCI compared to when RL Setup Request is sent to only one cell in order not to wait a long time on RLs that will be deleted afterwards. The RL connection is deleted in both the radio network node 140 and in the non-selected cell.

Actions described above will be described below in more detail from a perspective of the radio network node 140.

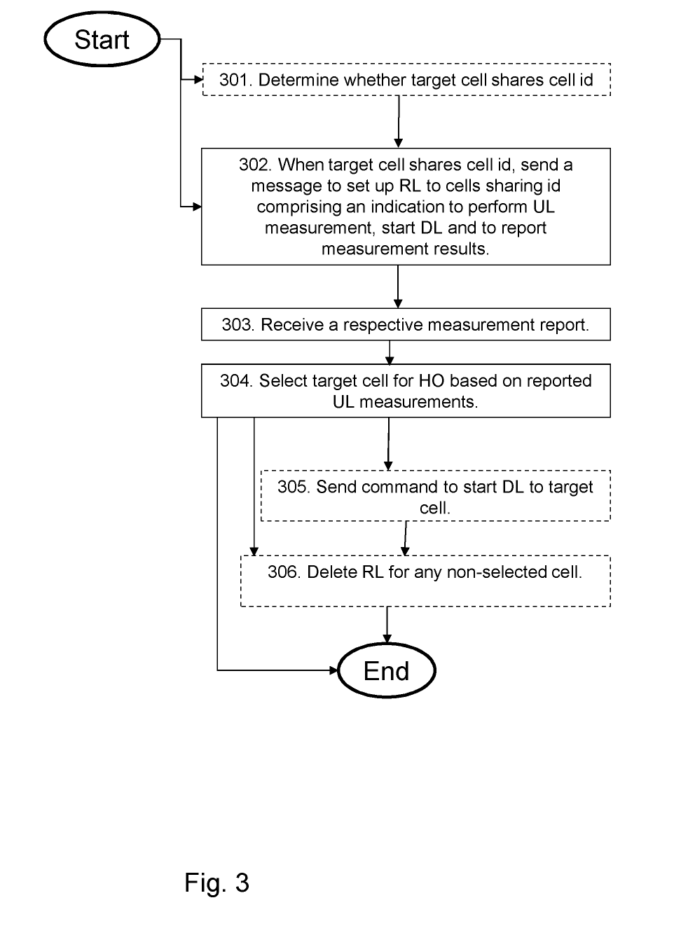

FIG. 3 is a schematic flowchart for a method in the radio network node 140 for handling handover of the user equipment 150 to the target cell 131. As mentioned above, the target cell 131 shares a locally reused PCI, such as a pSC, with the second cell 132 in the cellular communications network 100. The target cell 131 is served by the base station 111, while the second cell 132 may be served by the second base station 112. The base station 111 and the second base station 112 are controlled by the radio network node 140. The radio network node 140, the user equipment 150, the target cell 131, the second cell 132, the base station 111 and the second base station 112 are comprised in the cellular communications network 100.

Examples of embodiments of a method in the radio network node 140 for handling handover of the user equipment 150 to the target cell 131 will now be described with reference to the flowchart depicted in FIG. 3. The method comprises the following actions, which actions may be taken in any suitable order. Dashed lines of some boxes in FIG. 3 indicate that this action is not mandatory.

Action 301

The radio network node 140 determines whether the target cell 131 is one of the at least two cells 131, 132 sharing the PCI or not. This action is in some embodiments performed after having received the handover measurement report from the user equipment 150 mentioned above in action 202.

The radio network node 140 can use different methods to determine if the target cell 131 shares the PCI with the second cell 132 or not.

The radio network node 140 may determine whether the target cell 131 is one of the at least two cells 131, 132 sharing the PCI or not by comparing the PCI of the target cell 131 to one or more ranges of PCIs dedicated to cells sharing PCI. In this way the radio network node 140 knows directly if the PCI received in the report for handover is locally reused or not.

In some alternative embodiments the radio network node 140 determines whether the target cell 131 is one of the at least two cells 131, 132 sharing the PCI or not by reading information about whether the PCI is locally reused or not stored in the neighbor set.

When the radio network node 140 has determined that the target cell 131 is one of the at least two cells 131, 132 sharing the PCI, the radio network node 140 determines which other cells that share the PCI. This action is related to action 203 above.

Action 302

When the target cell 131 is one of the at least two cells 131, 132 sharing the PCI, the radio network node 140 sends a message to the respective at least two cells 131 and 132. The message requests to set up an RL to the user equipment 150 and comprises an indication to measure a characteristic of an UL synchronization of the respective at least two cells 131, 132 with the user equipment 150.

The message further comprises an indication to send a report comprising a result of the indicated measurement to the radio network node 140. The report may be comprised in a “RL Restore Indication” message, which message is used when a base station detects UL synchronization.

The indication may indicate to start a DL radio connection in the respective at least two cells 131, 132 when the UL synchronization has been detected. Starting the DL radio connection directly after UL synchronization reduces the number of signaling steps compared to sending an explicit signal to start the DL radio connection when the target cell 131 has been selected and thus may improve the performance of the network.

In some other alternative embodiments the indication indicates to start a DL radio connection in the respective at least two cells 131, 132 when a command to start the DL radio connection to the user equipment 150 has been received. The command may be a “Radio link activation command”. Starting the DL radio connection from only the target cell 131 may save radio resources.

In some embodiments the sent message to the respective at least two cells 131, 132 is a Radio Link, RL, Setup Request message.

The indication comprised in the RL Setup Request message may be an Information Element, IE, “Delayed Activation” set to be active.

Action 303

In this action the radio network node 140 receives from at least one of the at least two cells 131, 132 a respective report, which respective report comprises a result of the indicated UL measurement.

In some embodiments the received respective report comprises a result of a measurement of a signal strength of the UL synchronization.

In some other embodiments the received respective report comprises a result of a measurement of a detection time of the UL synchronization.

Action 304

The radio network node 140 selects the target cell 131 for handover of the user equipment 150, based on the result in the respective report.

Action 305

When the target cell 131 has been selected for handover the radio network node 140 may send a message to the target cell 131 comprising a command to start the DL radio connection to the user equipment 150. The command to start the DL radio connection may be a “Radio link activation command”. This step may be performed if the base station 111 has interpreted the message requesting to set up the RL to the user equipment 150 as an indication to start the DL radio connection between the user equipment 150 and the base station 111 when a message comprising a command to start the radio connection to the user equipment 150 has been received.

Action 306

The radio network node 140 may delete the RL connection between the user equipment 150 and the at least two cells 131, 132 for any non-selected cell out of the at least two cells 131, 132 sharing the PCI. The deleting of the RL connection may be performed explicitly, while in some embodiments the deleting of the RL connection is performed by time-out.

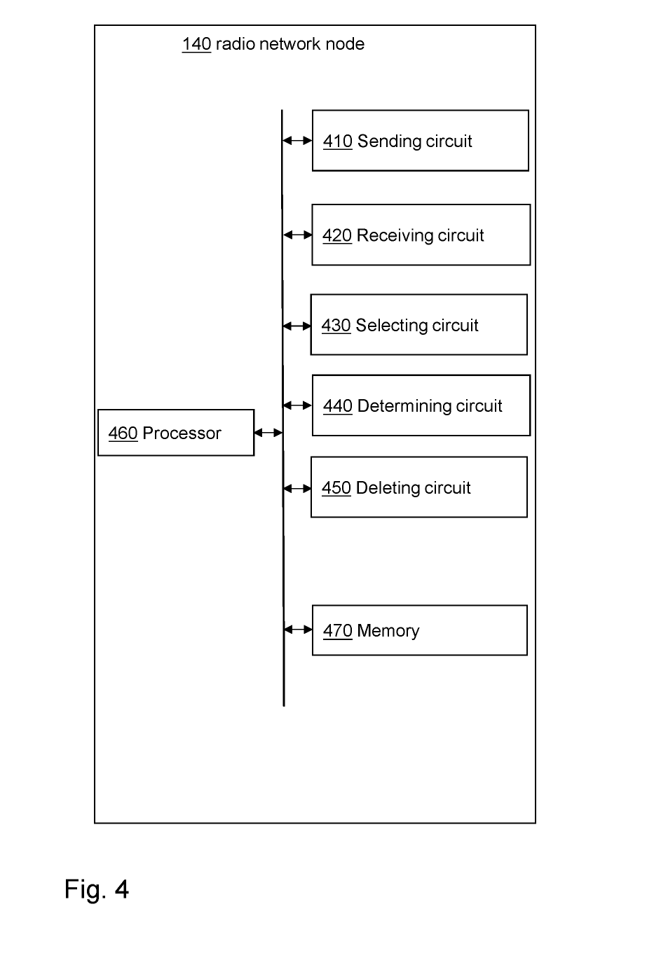

To perform the method actions for handling handover in a wireless communications system 100 described above in relation to FIG. 3, the radio network node 140 comprises the following arrangement depicted in FIG. 4.

As mentioned above, the target cell 131 shares a locally reused PCI, such as a pSC, with the second cell 132 in the cellular communications network 100. The target cell 131 is served by the base station 111, while the second cell 132 may be served by the second base station 112. The base station 111 and the second base station 112 are controlled by the radio network node 140. The radio network node 140, the user equipment 150, the target cell 131, the second cell 132, the base station 111 and the second base station 112 are comprised in the cellular communications network 100.

The radio network node 140 comprises a sending circuit 410 configured to send a message to the respective at least two cells 131, 132 when the target cell 131 is one of the at least two cells 131, 132 sharing the PCI. The message requests to set up a RL to the user equipment 150 and comprises an indication to measure a characteristic of an UL synchronization of the at least two cells 131, 132 with the user equipment 150. The message further comprises an indication to send a report to the radio network node 140. The report comprises a result of the indicated measurement

The indication may indicate to start a DL radio connection in the respective at least two cells 131, 132 when the UL synchronization has been detected or when a command to start the DL radio connection to the user equipment 150 has been received.

In some embodiments the sent message to the respective at least two cells 131, 132 is a RL Setup Request message.

The indication comprised in the RL Setup Request message may be an Information Element, IE, “Delayed Activation” set to be active.

The radio network node 140 further comprises a receiving circuit 420 configured to receive from at least one of the at least two cells 131, 132 a respective report, which respective report comprises a result of the indicated UL measurement.

In some embodiments the received respective report comprises a result of a measurement of a signal strength of the UL synchronization.

In some other embodiments the received respective report comprises a result of a measurement of a detection time of the UL synchronization.

The radio network node 140 further comprises a selecting circuit 430 configured to select the target cell 131 for handover of the user equipment 150, based on the result in the report.

In some embodiments the radio network node 140 further comprises a determining circuit 440 configured to determine whether the target cell 131 is one of the at least two cells 131, 132 sharing the PCI or not.

The determining circuit 440 may further be adapted to determine whether the target cell 131 is one of the at least two cells 131, 132 sharing the PCI or not by comparing the PCI of the target cell 131 to one or more ranges of PCIs dedicated to cells sharing PCI.

In some embodiments the determining circuit 440 further is adapted to determine whether the target cell 131 is one of the at least two cells 131, 132 sharing the PCI or not by reading information about whether the PCI is locally reused or not stored in a neighbor set.

In some embodiments the radio network node 140 may further comprise a deleting circuit 450 adapted to delete the RL connection between the user equipment 150 and the at least two cells 131, 132 for any non-selected cell out of the at least two cells 131, 132 sharing the PCI.

The embodiments herein for handling handover may be implemented through one or more processors, such as a processor 460 in the radio network node 140 depicted in FIG. 4, together with computer program code for performing the functions and actions of the embodiments herein. The program code mentioned above may also be provided as a computer program product, for instance in the form of a data carrier carrying computer program code for performing the embodiments herein when being loaded into the in the radio network node 140. One such carrier may be in the form of a CD ROM disc. It is however feasible with other data carriers such as a memory stick. The computer program code may furthermore be provided as pure program code on a server and downloaded to the radio network node 140.

The radio network node 140 may further comprise a memory 470 comprising one or more memory units. The memory 470 is arranged to store information obtained from for example the base station 111 or from the second base station 112 or from the user equipment 150. Such information may be information about the UL measurement, the neighbor set, which cells that share the PCI of the target cell, etc. The memory 470 may also store configurations and applications to perform the methods herein when being executed in the radio network node 140.

Those skilled in the art will also appreciate that the sending circuit 410, receiving circuit 420, selecting circuit 430, determining circuit 440 and deleting circuit 450 described above may refer to a combination of analog and digital circuits, and/or one or more processors configured with software and/or firmware, e.g. stored in a memory, that when executed by the one or more processors such as the processor 460 perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

Actions described above will be described below in more detail from a perspective of the base station 111. It should be noted that the same actions are valid for the second base station 112 that may be serving the second cell 132. Therefor the base station 111 and the second base station 112 are referred to as the base station 111, 112 below.

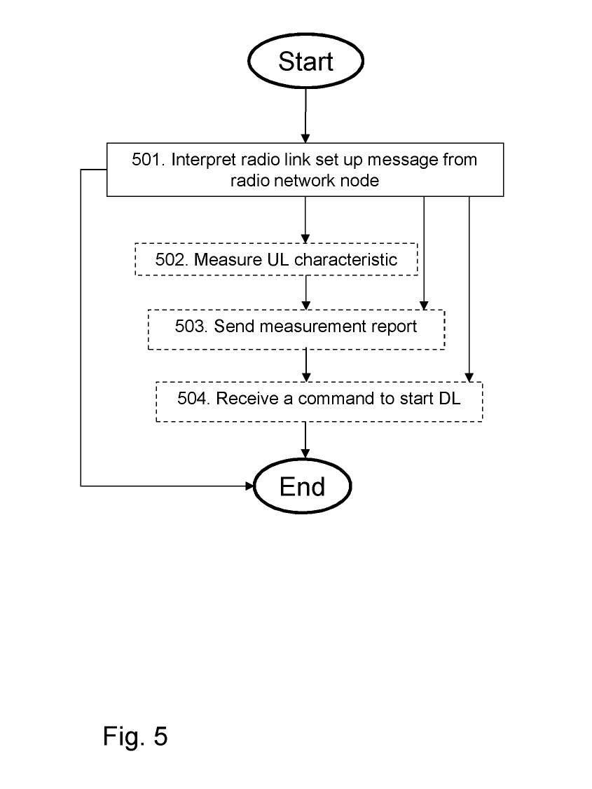

Examples of embodiments of a method in the base station 111, 112 for handling handover in a wireless communications system 100 will now be described with reference to the flowchart depicted in FIG. 5.

As mentioned above the target cell 131 is served by the base station 111, while the second cell 132 may be served by the second base station 112. The base station 111 and the second base station 112 are controlled by the radio network node 140. The radio network node 140, the user equipment 150, the target cell 131, the second cell 132, the base station 111 and the second base station 112 are comprised in the cellular communications network 100.

The method comprises the following actions, which actions may be taken in any suitable order. Dashed lines of some boxes in FIG. 5 indicate that this action is not mandatory.

Action 501

The base station 111, 112 interprets the received message as the indication to measure the characteristic of the UL synchronization of the at least two cells 131, 132 with the user equipment 150. The message is further interpreted as the indication to send the report to the radio network node 140 in response to the message from the radio network node 140. The report comprises the result of the indicated UL synchronization measurement. The result will be used by the radio network node 140 for selecting the target cell 131 for handover of the user equipment 150.

The received message may be an RL Setup Request message comprising an Information Element, IE, “Delayed Activation”, which is set to be active, and which IE “Delayed Activation” set to be active is interpreted as the indication to measure the characteristic of the UL synchronization.

In some embodiments the received message is further interpreted as to start the DL radio connection between the user equipment 150 and the base station 111 directly after the UL synchronization has been detected.

In some alternative embodiments the received message may be interpreted as an indication to start a DL radio connection in the respective at least two cells 131, 132 when a command to start the DL radio connection to the user equipment 150 has been received, i.e. not directly after UL synchronization but after the target cell 131 has been selected.

Action 502

The base station 111, 112 measures a characteristic of the UL synchronization according to the interpreted indication in the received message from the radio network node 140.

In some embodiments this action is performed by measuring a signal strength of the UL synchronization.

This action may also be performed by measuring a detection time of the UL synchronization.

Action 503

When the base station 111, 112 has measured the characteristic of the UL synchronization of the respective at least two cells 131, 132 with the user equipment 150 the base station 111, 112 may send the report to the radio network node 140 in response to the received message in action 205. The report may comprise a result of the indicated UL measurements and the result will be used by the radio network node 140 for selecting the target cell 131 for handover of the user equipment 150.

In some embodiments this action is performed by sending the respective report comprising a result of a measurement of the signal strength of the UL synchronization.

In some alternative embodiments this action is performed by sending the report comprising a result of a measurement of the detection time of the UL synchronization.

Action 504

When the target cell 131 has been selected for handover the base station 111 may receive a command to start the DL radio connection to the user equipment 150, which command may be sent in a message from the radio network node 140.

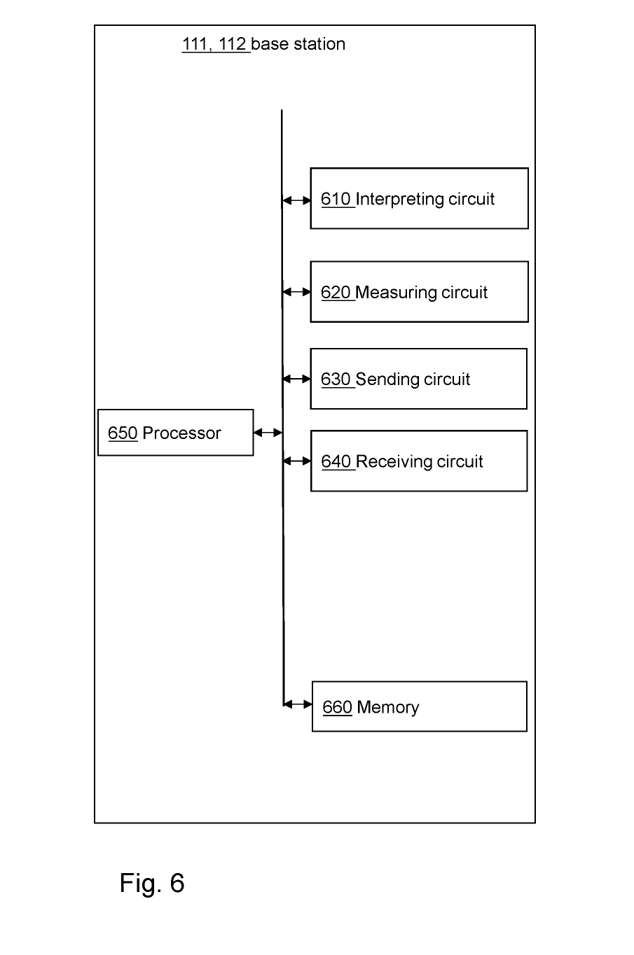

To perform the method actions of for handling handover in a wireless communications system 100 described above in relation to FIG. 5, the base station 111, 112 comprises the following arrangement depicted in FIG. 6. As mentioned above, the target cell 131 shares a locally reused PCI, such as a pSC, with the second cell 132 in the cellular communications network 100. The target cell 131 is served by the base station 111. The base station 111 and the second base station 112 are controlled by the radio network node 140. The radio network node 140, the user equipment 150, the target cell 131, the second cell 132, the base station 111 and the second base station 112 are comprised in the cellular communications network 100.

The base station 111, 112 comprises an interpreting circuit 610 configured to interpret a received message from the radio network node 140, which message requests to set up a RL to the user equipment 150, as an indication to measure a characteristic of an UL synchronization of the respective at least two cells 131, 132 with the user equipment 150.

The interpreting circuit 610 is further configured to interpret the received message from the radio network node 140 as an indication to send a report to the radio network node 140 in response to the message from the radio network node 140, the report comprising a result of the indicated UL synchronization measurement.

The received message may be an RL Setup Request message comprising an Information Element, IE, “Delayed Activation”, which is set to be active, and which IE “Delayed Activation” set to be active may be interpreted as the indication to measure the characteristic of the UL synchronization.

In some embodiments the interpreting circuit 610 is further configured to interpret the received indication as to start a DL radio connection between the user equipment 150 and the base station 111 when the UL synchronization signal has been detected or when a message comprising a command to start the DL radio connection to the user equipment 150 has been received.

In some embodiments the base station 111 further comprises a measuring circuit 620 configured to measure a characteristic of the UL synchronization according to the interpreted indication in the received message.

In some embodiments the measuring circuit 620 further is configured to measure the characteristic of the UL synchronization by being configured to measure a signal strength.

The measuring circuit 620 may further be configured to measure the characteristic of the UL synchronization by being configured to measure a detection time of the UL synchronization.

In some embodiments the base station 111 further comprises a sending circuit 630 configured to send a report to the radio network node 140 in response to the received message, which report comprises a result of the indicated UL measurements, which result will be used by the radio network node 140 for selecting the target cell 131 for handover of the UE 150.

In some embodiments the sending circuit 630 further is configured to send the report by being configured to send a result of a measurement of the signal strength of the UL synchronization.

The sending circuit 630 may further be configured to send the report by being configured to send a result of a measurement of the detection time of the UL synchronization.

The embodiments herein for handling handover may be implemented through one or more processors, such as a processor 650 in the base station 111 or the second base station 112 depicted in FIG. 6, together with computer program code for performing the functions and actions of the embodiments herein. The program code mentioned above may also be provided as a computer program product, for instance in the form of a data carrier carrying computer program code for performing the embodiments herein when being loaded into the in the base station 111 or the second base station 112. One such carrier may be in the form of a CD ROM disc. It is however feasible with other data carriers such as a memory stick. The computer program code may furthermore be provided as pure program code on a server and downloaded to the base station 111 or the second base station 112.

The base station 111 and the second base station 112 may each further comprise a memory 660 comprising one or more memory units. The memory 660 is arranged to store information obtained from the radio network node 140 and the user equipment 150. The memory is further arranged to store applications to perform the methods herein when being executed in the base station 111 or in the second base station 112.

Those skilled in the art will also appreciate that the interpreting circuit 610, the measuring circuit 620, the sending circuit 630 and the receiving circuit 640 described above may refer to a combination of analog and digital circuits, and/or one or more processors configured with software and/or firmware, e.g. stored in a memory, that when executed by the one or more processors such as the processor 650 perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1-30. (canceled)

31. A method in a radio network node for handling handover of a User Equipment (UE) to a target cell, which target cell shares a physical cell identity (PCI) with at least a second cell in a cellular communications network, which cellular communications network comprises the radio network node, the UE and the at least two cells sharing the PCI, the method comprising:
when the target cell for a handover is one of the at least two cells sharing the PCI, sending a message to the respective at least two cells, where each message requests to set up a radio link (RL) to the UE and comprises an indication to measure a characteristic of an uplink (UL) synchronization of the respective at least two cells with the UE and which message comprises an indication to send a report comprising a result of the indicated measurement to the radio network node;
receiving from at least one of the at least two cells a respective report, which respective report comprises a result of the indicated UL measurement;
selecting the target cell for handover of the UE, based on the result in the report.

32. The method of claim 31, further comprising determining whether or not the target cell is one of the at least two cells sharing the PCI or not.

33. The method of claim 32, wherein the determining of whether or not the target cell is one of the at least two cells sharing the PCI is performed by comparing the PCI of the target cell to one or more ranges of PCIs dedicated to cells sharing PCI.

34. The method of claim 32, wherein the determining of whether or not the target cell is one of the at least two cells sharing the PCI is performed by reading information about whether the PCI is locally reused or not stored in a neighbor set.

35. The method of claim 31, wherein the received respective report comprises one or more of:
a result of a measurement of a signal strength of the UL synchronization; and
a result of a measurement of a detection time of the UL synchronization.

36. The method of claim 31, wherein the sent message to the respective at least two cells further comprises an indication to start a downlink (DL) radio connection in the respective at least two cells when the UL synchronization has been detected, or when a command to start the DL radio connection to the UE has been received.

37. The method of claim 31, further comprising deleting the RL connection between the UE and the at least two cells for any non-selected cell out of the at least two cells sharing the PCI.

38. A radio network node for handling handover of a User Equipment (UE) to a target cell, which target cell shares a physical cell identity (PCI) with at least a second cell in a cellular communications network, which cellular communications network is configured to comprise the radio network node, the UE and the at least two cells sharing the PCI, the radio network node comprising a processing circuit configured to:
send a message to the respective at least two cells, where each message requests to set up a radio link (RL) to the UE and comprises an indication to measure a characteristic of an uplink (UL) synchronization of the at least two cells with the UE and which message comprises an indication to send a report comprising a result of the indicated measurement to the radio network node, when the target cell is one of the at least two cells sharing the PCI,
receive from at least one of the at least two cells a respective report, which respective report comprises a result of the indicated UL measurement,
select the target cell for handover of the UE, based on the result in the report.

39. The radio network node of claim 38, wherein the processing circuit is further configured to determine whether or not the target cell is one of the at least two cells sharing the PCI or not by comparing the PCI of the target cell to one or more ranges of PCIs dedicated to cells sharing PCI.

40. The radio network node of claim 38, wherein the received respective report comprises one or more of:
a result of a measurement of a signal strength of the UL synchronization; and
a result of a measurement of a detection time of the UL synchronization.

41. The radio network node of claim 38, wherein sending the message to the respective at least two cells further comprises including in the message an indication to start a downlink (DL) radio connection in the respective at least two cells when the UL synchronization has been detected or when a command to start the DL radio connection to the UE has been received.

42. The radio network node of claim 41, wherein the processing circuit is further configured to delete the RL connection between the UE and the at least two cells for any non-selected cell out of the at least two cells sharing the PCI.

43. A method in a base station for handling handover of a User Equipment (UE) to a target cell, which target cell shares a physical cell identity (PCI) with at least a second cell in a cellular communications network, which cellular communications network comprises a radio network node, the UE, the at least two cells sharing the PCI and the base station, which base station serves the target cell, the method comprising:
interpreting a received message from the radio network node, which message requests to set up a radio link (RL) to the UE, as an indication to measure a characteristic of an uplink (UL) synchronization of the at least two cells with the UE and as an indication to send a report to the radio network node in response to the message from the radio network node, the report comprising a result of the indicated UL synchronization measurement, which result will be used by the radio network node for selecting the target cell for handover of the UE; and
measuring a characteristic of the UL synchronization according to the interpreted indication in the received message.

44. The method of claim 43, further comprising:
sending a report to the radio network node in response to the received message, which report comprises a result of the indicated UL measurements, which result will be used by the radio network node for selecting the target cell for handover of the UE.

45. The method of claim 43, wherein the received message is an RL Setup Request message comprising an Information Element (IE) “Delayed Activation”, which is set to be active, and which IE “Delayed Activation” set to be active is interpreted as the indication to measure the characteristic of the UL synchronization.

46. The method of claim 43, wherein the received indication further is interpreted as to start a downlink (DL) radio connection between the UE and the base station when the UL synchronization has been detected or when a command to start the DL radio connection to the UE has been received.

47. The method of claim 43, wherein the measuring of the characteristic of the UL synchronization comprises measuring a signal strength of the UL synchronization, and wherein the sending of the report comprises sending a result of a measurement of the signal strength of the UL synchronization.

48. The method of claim 43, wherein the measuring of the characteristic of the UL synchronization comprises measuring a detection time of the UL synchronization, and wherein the sending of the report comprises sending a result of a measurement of the detection time of the UL synchronization.

49. A base station for handling handover of a User Equipment (UE) to a target cell, which target cell shares a physical cell identity (PCI) with at least a second cell in a cellular communications network, which cellular communications network comprises a radio network node, the UE, the at least two cells sharing the PCI and the base station, which base station serves the target cell, the base station comprising a processing circuit configured to:
interpret a received message from the radio network node, which message requests to set up a radio link (RL) to the UE, as an indication to measure a characteristic of an uplink (UL) synchronization of the respective at least two cells with the UE and as an indication to send a report to the radio network node in response to the message from the radio network node, the report comprising a result of the indicated UL synchronization measurement, which result will be used by the radio network node for selecting the target cell for handover of the UE; and
measure a characteristic of the UL synchronization according to the interpreted indication in the received message.

50. The base station of claim 49, wherein the received indication further is interpreted as to start a downlink (DL) radio connection between the UE and the base station when the UL synchronization signal has been detected or when a command to start the DL radio connection to the UE has been received.
